(19) United States
(12) Patent Application Publication
(10) Pub. No.: US 2015/0230400 A1
(43) Pub. Date: Aug. 20, 2015

(54) Hand-Held Leaf Scoopers

(71) Applicant: Muoi Tia, Savage, MN (US)

(72) Inventor: Muoi Tia, Savage, MN (US)

(21) Appl. No.: 14/604,884

(22) Filed: Jan. 26, 2015

Related U.S. Application Data
(60) Provisional application No. 61/940,881, filed on Feb. 18, 2014.

(51) Int. Cl. A01D 7/00

(52) U.S. Cl. CPC A01D 7/00

(57) ABSTRACT

A pair of leaf scoopers for lifting piles of leaves and other debris. Each scooper is of the same construction and includes a scooper body having a handle on an upper end thereof and multiple elongated tines on a lower end thereof. The handle is formed by an opening through the scooper body in which a user's hand may be inserted so that the user may grasp the handle on the upper end of the scooper body. The elongated tines are arranged parallel to one another and have a curved end. The tines curve towards the direction in which leaves will be scooped. In operation, a user can hold a leaf scooper in each hand on opposite sides of a pile of leaves, and can then move the scoopers towards one another so as to grasp the pile of leaves therebetween.

### CROSS REFERENCE TO RELATED APPLICATION

This application claims the benefit of U.S. Provisional Application No. 61/940,881 filed on Feb. 18, 2014. The above identified patent application is herein incorporated by reference in its entirety to provide continuity of disclosure.

### BACKGROUND OF THE INVENTION

1. Field of the Invention

The present invention relates to a leaf scooping device. More specifically, the present invention provides a pair of hand-held leaf scoopers that can be used to pick up a pile of leaves for disposal. The leaf scoopers include a scooper body having a handle formed therein and having a plurality of elongated tines extending from a lower portion thereof.

Leaves are commonly raked or are otherwise collected in a pile for disposal. This helps to eliminate the messy appearance of leaves distributed across a lawn, yard, or other area. However, raking is a laborious, time consuming, and physically demanding activity that requires considerable effort. After raking the leaves into a pile, a person must then lift and transfer the pile of leaves into bags for disposal. This process is difficult and time consuming, as the user may have to remove several piles of leaves and other debris.

People commonly transfer leaves from a pile and put them into a bag by hand. Picking up leaves by hand is time consuming as a person can only hold so many leaves at a time. Further, the user may miss some leaves and must continually attempt to gather all of the leaves from the pile. Picking up leaves by hand can cause the users hands to become dirty, and the user may even but cut or scraped by leaves, twigs, and other debris if the user is not wearing gloves. Thus, a device that allows a user to more easily transfer a pile leaves and other debris into a bag for disposal is desired.

The present invention provides a pair of hand-held leaf scoopers. Each leaf scooper comprises a scooper body having an upper end and a lower end. The scooper body is substantially planar and includes a handle formed by an opening through the body of the leaf scooper. A user can insert his or her hand through the opening so as to grasp the handle formed in the upper end of scooper. Further, the lower end of the scooper body includes a plurality of tines thereon. The tines are arranged parallel to one another and are of approximately equal length. The tines include curved ends, and are curved in the direction in which leaves will be scooped. Thus, the pair of leaf scoopers includes tines that face towards one another so that a pile of leaves can be picked up in between the pair of scoopers. The leaf scoopers allow a user to more easily grasp a larger amount of leaves than the user would be able to hold using their hands alone.

2. Description of the Prior Art

Devices have been disclosed in the prior art that relate to leaf and debris collecting devices. These include devices that have been patented and published in patent application publications. These devices generally relate to hand-held leaf collecting or raking devices. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 4,378,670 to Check et al. discloses a hand scoop for grass and leaves. The device includes a pair of concave scoops that are hand operated. The scoops include teeth that serve as rakes for gathering leaves and other debris into a pile that can then be transferred into a garbage bag. While Check et al. discloses scoops for gathering leaves and debris, Check et al. fails to disclose scoopers having a plurality of elongated tines with curved ends, and does not include scoopers having a handle formed in an upper end thereof.

U.S. Pat. No. 4,866,922 to Clark discloses a multipurpose rake having a head with tines thereon. An elongated handle is removably connected to the head of the rake. A hand-hold is also positioned on the upper portion of the rake head adjacent to the tines thereon. A strap is formed into a loop and is affixed to the handle end of the rake head. The user may use the tool as a conventional rake with an elongated handle, or may remove the handle and insert his or her hand through the loop and engage the hand-hold. Thus, Clark fails to disclose a pair of hand-held scoopers having parallel elongated tines, and a hand-hold formed by an opening through the scooper body.

U.S. Pat. No. 5,169,191 to Benz discloses a hand-scoop for leaves and grass. The scoops have hand holders shaped as pockets with thumb openings. Each scoop includes a rigid plate-like member with one straight side to be placed adjacent to the ground. The scoops include an inwardly turned lip along the edges to facilitate the retention of leaves and other debris. Thus, Benz discloses scoopers comprising flat plates, and does not disclose scoopers that include elongated tines thereon. Further, Benz does not disclose handles formed by openings in the body of the scooper, and instead discloses pockets in which the user's hands can be positioned.

U.S. Pat. No. 5,687,556 to Lintz discloses a rake system with arm extensions. A pair of rake heads with a plurality of tines thereon each include an arm extension having a handle thereon. The handle includes an angled grip shaft that defines an angled hand-hold. A forearm brace extends between the grip shaft and the arm extension. Thus, Lintz discloses a pair of rake heads having extension arms, and does not disclose scoopers having handles formed on the scooper body. Further, Lintz does not disclose scoopers having a plurality of parallel tines.

Finally, U.S. Pat. No. 5,609,012 to Anthes et al. discloses a raking apparatus to be worn on the hand of a user. The raking apparatus includes a plurality of L-shaped rake portions coupled together by a curved support rod. A palm receiving portion and a finger receiving portion are secured to the plurality of L-shaped rake portions. Thus, Anthes et al. discloses a device to be worn on the hands of a user, and does not disclose a scooper having a handle thereon for the user to hold.

These prior art devices have several known drawbacks. Devices in the prior art generally relate to hand-held scoopers for collecting and lifting piles of leaves and other debris. However, the devices in the prior art do not disclose a pair of scoopers having an opening through the scooper body that defines a handle on the upper end of the scooper body. Further, various devices disclose scoopers with tines that extend outward from the rake head at angles, and do not disclose a rake head having a plurality of elongated tines that are substantially parallel to one another. Thus, the present invention provides a pair of scoopers that is more easily maneuvered and that is better suited for picking up and transferring piles of leaves from one location to another.

In light of the devices disclosed in the prior art, it is submitted that the present invention substantially diverges in design elements from the prior art and consequently it is clear that there is a need in the art for an improvement to existing leaf collecting devices. In this regard the instant invention substantially fulfills these needs.

### SUMMARY OF THE INVENTION

In view of the foregoing disadvantages inherent in the known types of leaf collecting devices now present in the prior art, the present invention provides a new leaf collecting device wherein the same can be utilized for providing convenience for the user when transferring a pile of leaves to a bag for disposal.

It is therefore an object of the present invention to provide a new and improved leaf scooping device that has all of the advantages of the prior art and none of the disadvantages.

It is another object of the present invention to provide a leaf scooping device that comprises a pair of hand-held leaf scoopers for grasping a pile of leaves so that the pile may be transferred to another location for disposal.

Another object of the present invention is to provide a leaf scooping device comprising leaf scoopers that have a plurality of parallel elongated tines arranged thereon.

Yet another object of the present invention is to provide a leaf scooping device comprising a handle formed from an opening on the body of the leaf scooper.

Another object of the present invention is to provide a leaf scooper that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a pair of leaf scoopers of the present invention.

FIG. 2 shows a perspective view of a pair of leaf scoopers as used to pick up a pile of leaves.

### DETAILED DESCRIPTION OF THE INVENTION

Reference is made herein to the attached drawings. Like reference numerals are used throughout the drawings to depict like or similar elements of the leaf scoopers of the present invention. For the purposes of presenting a brief and clear description of the present invention, the preferred embodiment will be discussed as used for picking up a pile of leaves and transferring the leaves to a garbage bag or other area for disposal. The figures are intended for representative purposes only and should not be considered to be limiting in any respect.

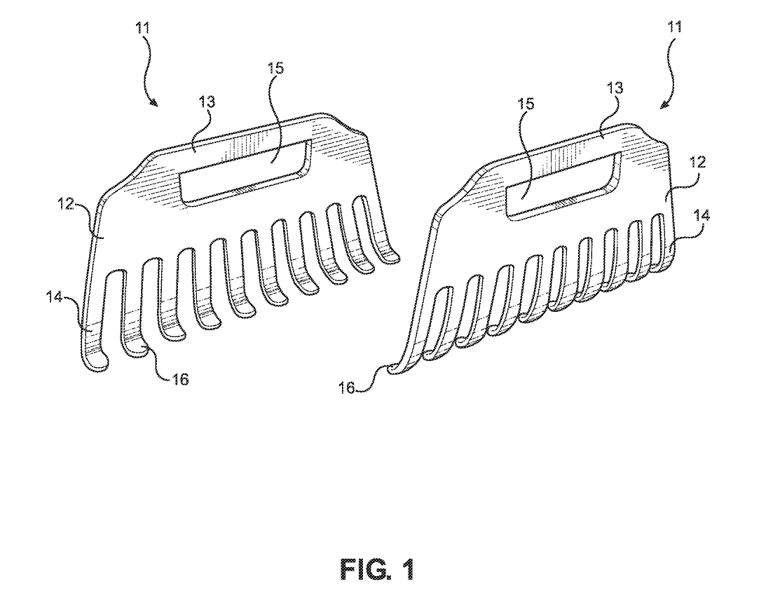

Referring now to FIG. 1, there is shown a perspective view of a pair of leaf scoopers of the present invention. The present invention provides a pair of leaf scoopers 11 that can be used to grasp a pile of leaves or other debris so that the pile may be transferred to a garbage bag or other area for disposal. Each leaf scooper 11 comprises a scooper body 12 having an upper end and a lower end. The scooper body 12 is preferably substantially planar, but may alternatively have an arcuate shape. The lower end includes a plurality of elongated tines 14 thereon. The scooper body 12 includes an opening 15 that defines a handle 13 on the upper end of the scooper body 12. The leaf scooper 11 is preferably comprised of a rigid, durable material, such as a hard plastic, or a metal, among others. Preferably, the leaf scooper 11 is composed of a corrosion resistant material so that the leaf scoopers do not rust after prolonged exposure to water or moisture.

The upper end of the scooper body 12 includes an integrally formed handle 13 thereon that is defined by an opening 15 that extends through the scooper body 12. In the illustrated embodiment, the opening 15 is substantially rectangular, however, in alternate embodiments the opening 15 may comprise other shapes, such as an elliptical shape. The user may insert his or her hand through the opening 15 and grasp the handle 13 on the upper end of the scooper body 12. In this way, the user can easily maneuver and articulate the leaf scooper 11 as desired. Further, the handle 13 at the upper end of the scooper body 12 prevents the user's hands from coming into contact with leaves and other debris collected on the elongated tines 14 on the lower end of the scooper 11. The handle 13 can be padded or cushioned so that the handle 13 is comfortable to hold and can be easily grasped.

The lower end of the scooper body 12 includes a plurality of elongated tines 14 thereon. The tines 14 are substantially parallel to one another and are spaced at a fixed interval. The tines 14 are substantially flat and are linear in configuration. The tines 14 extend the entire length of the scooper body 12, and extend from a first side thereof to a second side thereof. The tines 14 are adapted to collect leaves and other debris, and can be used to rake the surface of the ground. The tines 14 preferably include a curved lower end 16, wherein the lower end 16 curves towards the direction in which leaves will be scooped. The outermost tines 14 may include a lip thereon for preventing leaves and debris from falling off of the sides of the scooper 11.

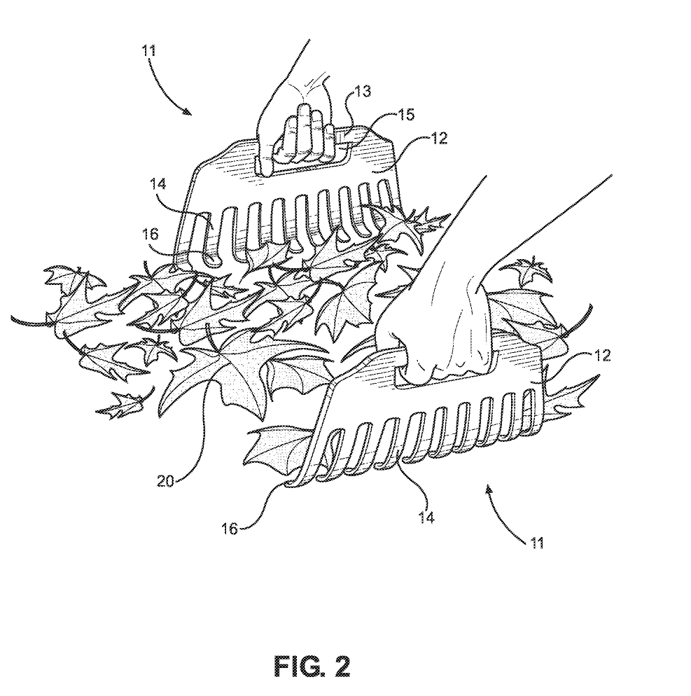

Referring now to FIG. 2, there is shown a perspective view of a pair of leaf scoopers as used to pick up a pile of leaves. In operation, a user can hold a scooper 11 in each hand by placing his or her hand through the opening 15 on each scooper and by grasping the handle 13 thereon. The user can place the scoopers 11 on opposing sides of a pile of leaves and other debris such that the curved lower ends 16 of the tines 14 are facing one another. Thus, the tines 14 can scrape against the ground to collect leaves and debris and can be used to grasp the pile of leaves and debris so that it may be lifted and transferred to a garbage bag or other disposal area. The curved lower ends 16 of the tines 14 helps to prevent leaves and debris from falling downward in the space between the scoopers 11. The user can easily maneuver the scoopers 11 in order to gather and collect leaves and debris for disposal.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pair of scoopers for gathering leaves and debris, each scooper comprising:
a scooper body having an upper end and a lower end;
wherein said lower end of said scooper body comprises a plurality of elongated tines thereon, said elongated tines being substantially parallel to one another;
said scooper body having an opening therethrough defining a handle on said upper end, wherein said opening is adapted to receive a user's hand therethrough.

2) The scooper of claim 1, wherein said plurality of elongated tines are spaced at a fixed interval.

3) The scooper of claim 1, wherein said plurality of elongated tines curve outward at an end thereof.

4) The scooper of claim 1, wherein said scooper body is substantially planar.

5) The scooper of claim 1, wherein said opening comprises a rectangular shape.

6) The scooper of claim 1, wherein said handle on said upper end comprises padding thereon.
